(19) United States
(12) Patent Application Publication
(10) Pub. No.: US 2013/0249493 A1
(43) Pub. Date: Sep. 26, 2013

(54) VEHICLE AND METHOD OF CONTROLLING THE SAME

(71) Applicants: Hyun Kim, Yongin-si (KR); Ri-A Ju, Yongin-si (KR); Ji-Hong Lim, Yongin-si (KR); Suk-Kyum Kim, Yongin-si (KR); Seong-Joon Park, Yongin-si (KR)

(72) Inventors: Hyun Kim, Yongin-si (KR); Ri-A Ju, Yongin-si (KR); Ji-Hong Lim, Yongin-si (KR); Suk-Kyum Kim, Yongin-si (KR); Seong-Joon Park, Yongin-si (KR)

(73) Assignee: Samsung SDI Co., Ltd, Yongin-si (KR)

(21) Appl. No.: 13/615,088

(22) Filed: Sep. 13, 2012

(30) Foreign Application Priority Data
Mar. 23, 2012 (KR) 10-2012-0030236

(51) Int. Cl. H02J 7/14; H02J 7/00

(52) U.S. Cl. 320/134; 320/150

(57) ABSTRACT

An electrical system, such as for use in a vehicle is disclosed. The system includes a battery cell that is receives a charge current from a power generation module in order to be charged, and a diode between the power generation module and the battery cell, which allows the charge current to flow therethrough. The system also includes a control unit that adjusts the charge current according to a temperature of the diode.

### CROSS-REFERENCE TO RELATED APPLICATIONS

This application claims the benefit of Korean Patent Application No. 10-2012-0030236, filed on Mar. 23, 2012, in the Korean Intellectual Property Office, the disclosure of which is incorporated herein in its entirety by reference.

### BACKGROUND

1. Field

The disclosed technology relates to an electrical system, such as a vehicle and a method of controlling the same.

2. Description of the Related Technology

Unlike primary batteries, secondary batteries are rechargeable batteries. Secondary batteries are used as energy sources in, for example, mobile devices, electric cars, hybrid cars, electric bicycles, or uninterruptible power supply devices. Secondary batteries include a single battery or a battery module including multiple batteries according to the type of device to be supplied with power.

Typically, lead storage batteries are used as power sources for starting up engines. Idle stop and go (ISG) systems for improving fuel economy have recently been developed and are expected to be widely used. Power sources which support ISG systems supply high power to start up engines, maintain strong charge and discharge characteristics even when the engines are repeatedly restarted, and have long life spans. Typically, however, as engines of ISG systems are repeatedly stopped and restarted, charge and discharge characteristics of conventional lead storage batteries quickly degrade.

SUMMARY OF CERTAIN INVENTIVE ASPECTS

One inventive aspect is a vehicle having a rechargeable battery charging system, which includes a battery cell configured to receive a charge current from a power generation module in order to be charged, a diode connected in series between the power generation module and the battery cell and configured to conduct the charge current therethrough, and a control unit that adjusts the charge current supplied from the power generation module according to a temperature of the diode.

Another inventive aspect is a method of controlling a vehicle that supplies a charge current to a rechargeable battery cell from a power generation module through a diode. The method includes measuring a temperature of the diode, and adjusting the charge current supplied from the power generation module according to the temperature of the diode.

Another inventive aspect is a rechargeable battery charging system, which includes a battery cell configured to receive a charge current from a power generation module in order to be charged, a diode connected in series between the power generation module and the battery cell and allows the charge current to flow therethrough, and a control unit that adjusts the charge current supplied from the power generation module according to a temperature of the diode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a vehicle according to an embodiment;

FIG. 2 is a block diagram illustrating a battery pack according to an embodiment;

FIG. 3 illustrates graphs which show relationships between a voltage of a battery cell and time and between a temperature of a diode and a temperature of the battery cell and time;

FIG. 4 is a flowchart illustrating a method of controlling the vehicle, according to an embodiment;

FIG. 5 is a block diagram illustrating a battery pack according to another embodiment;

FIG. 6 illustrates graphs which show relationships between a voltage of the battery cell and time and between a temperature of the diode and a temperature of the battery cell and a time; and

FIG. 7 is a flowchart illustrating a method of controlling the vehicle, according to another embodiment.

### DETAILED DESCRIPTION OF CERTAIN INVENTIVE EMBODIMENTS

Hereinafter, certain aspects and features are described more fully with reference to the accompanying drawings, in which exemplary embodiments are shown. The invention may, however, be embodied in many different forms and should not be construed as being limited to the embodiments set forth herein. The terminology used herein is for the purpose of describing particular embodiments only and is not intended to be limiting of the exemplary embodiments. As used herein, the singular forms “a,” “an” and “the” are intended to include the plural forms as well, unless the context clearly indicates otherwise. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof. It will be understood that, although the terms first, second, etc. may be used herein to describe various elements, these elements should not be limited by these terms. These terms are only used to distinguish one element from another.

As used herein, the term “and/or” includes any and all combinations of one or more of the associated listed items. Expressions such as “at least one of,” when preceding a list of elements, modify the entire list of elements and do not modify the individual elements of the list.

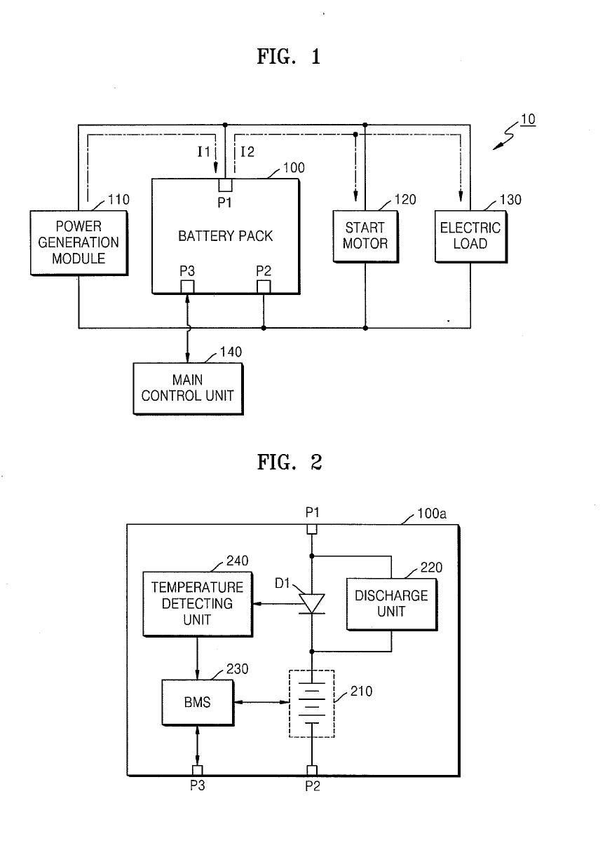

FIG. 1 is a block diagram illustrating an electrical system, such as a vehicle 10 according to an embodiment of the present invention. As shown, a battery pack 100 may be included in the vehicle 10, which may have an engine (not shown). The vehicle 10 may be, for example, a car or an electric bicycle.

The battery pack 100 may be supplied with a charge current I1 generated by a power generation module 110, store electric energy, and supply a discharge current I2 to a starter motor 120. For example, the power generation module 110 may be electrically connected to the engine, especially, to a driving shaft of the engine, and may convert rotational power into electric power. In this case, the charge current I1 generated by the power generation module 110 may be supplied to the battery pack 100. For example, the power generation module 110 may include a direct current (DC) generator (not shown) or an alternating current (AC) generator (not shown) with a rectifier (not shown). The power generation module 110 may supply a DC voltage of about 15 V, more specifically, a DC voltage of about 14.2 V to about 14.8 V.

For example, the starter motor 120 may operate when the engine is started up, and may supply initial rotational power for rotating the driving shaft of the engine. For example, the starter motor 120 may be supplied with stored power through first and second terminals P1 and P2 of the battery pack 100 and may start up the engine by rotating the driving shaft when the engine operates or re-operates after an idle-stop. The starter motor 120 may operate when the engine is started up, and the generating module 110 may be driven to generate the charge current I1 while the engine started up by the starter motor 120 is operating.

For example, the battery pack 100 may be used as a power source for starting up an engine of an idle stop and go (ISG) system with an ISG feature for improving fuel economy. In the ISG system, as the engine is repeatedly stopped and restarted, the battery pack 100 is repeatedly charged and discharged.

As a conventional lead storage battery applied to an ISG system is repeatedly charged and discharged, the durability of the lead storage battery is reduced and charge and discharge characteristics of the lead storage battery are degraded. For example, as the lead storage battery is repeatedly charged and discharged, a charge capacity is reduced, start-up characteristics of an engine are degraded, and an exchange cycle of the lead storage battery is shortened.

However, since the battery pack 100 includes a lithium-ion battery whose charge and discharge characteristics are maintained constant and which hardly degrades with time, compared to a lead storage battery, the battery pack 100 may be advantageously applied to an ISG system in which an engine is repeatedly stopped and restarted. Also, since the battery pack 100 is lighter than a lead storage battery having the same charge capacity, the system using the battery pack 100 may have better fuel economy than if the lead storage battery were used. Also, since the battery pack 100 has the same charge capacity even with a smaller volume than that of a lead storage battery, space occupied by the battery pack 100 may be smaller than that by the lead storage battery.

Although the battery pack 100 includes a lithium-ion battery in FIG. 1, embodiments are not limited thereto and the battery pack 100 may have any of various batteries. However, a battery included in the battery pack 100 may have a rated voltage less than an output voltage of the power generation module 110. For example, a nickel-metal hydride (NiMH) battery or a nickel-cadmium battery may be used in the battery pack 100.

One or more electrical loads 130 as well as the power generation module 110 and the starter motor 120 may be connected to the battery pack 100. The number and types of the electrical loads 130 may vary according to the vehicle 10. The electrical loads 130 that consume power stored in the battery pack 100 may be supplied with the discharge current I2 from the battery pack 100 through the first and second terminals P1 and P2. The electrical loads 130 may be various electronic devices such as navigation systems, audio players, lighting apparatuses, black boxes, and anti-theft apparatuses.

A main control unit 140 controls an overall operation of the vehicle 10 on which the battery pack 100 is mounted. The main control unit 140 may be connected to the battery pack 100 through a third terminal P3 to exchange a control signal, monitor a state of the battery pack 100, and control an operation of the battery pack 100. Also, the main control unit 140 may adjust the charge current I1 of the power generation module 110. The main control unit 140 may, for example, increase or reduce the charge current I1 of the power generation module 110 according to a monitored state of charge of the battery pack 100.

The main control unit 140 may act as a control unit of the vehicle 10 for controlling both the vehicle 10 and the battery pack 100. Alternatively, the main control unit 140 and a battery control unit may be separately formed, and the main control unit 140 may control the charge current I1 of the power generation module 110 according to data or a control signal applied from the battery control unit. Even in this case, a control unit of the vehicle 10 for controlling the charge current I1 of the power generation module 110 is the main control unit 140. In the following, it is assumed that the main control unit 140 and the battery control unit are separately formed.

FIG. 2 is a block diagram illustrating a battery pack 100a according to an embodiment. Referring to FIG. 2, the battery pack 100a includes a battery cell 210, a diode D1, a discharge unit 220, a battery management system (BMS) 230, and a temperature detecting unit 240.

The battery cell 210 may, for example, be a lithium-ion battery cell or a NiMH battery cell. The battery cell 210 is supplied with a charge current from the power generation module 110 in order to be charged. Also, the battery cell 210 may supply power to the starter motor 120 and the electrical loads 130. In FIG. 2, a rated voltage of the battery cell 210 is less than an output voltage of the power generation module 110. For example, if the battery cell 210 is a lithium-ion battery, the power generation module may supply a DC voltage of about 14.2 V to about 14.8 V, and the lithium-ion battery may have a DC rated voltage of about 12.6 V to about 13.05 V.

The diode D1 is connected in series between the first terminal P1 and the battery cell 210, and supplies the charge current I1 input from the first terminal P1 to the battery cell 210. The diode D1 is configured to exhibit a voltage drop corresponding to a voltage difference between the output voltage of the power generation module 110 and the rated voltage of the battery cell 210. The diode D1 forms a charge path of the battery pack 100a, wherein an anode of the diode D1 is connected to the first terminal P1 and a cathode of the diode D1 is connected to the battery cell 210. The diode D1 may include one diode, a plurality of diodes connected in series, and/or a plurality of diodes connected in parallel.

The discharge unit 220 forms a discharge path around and is connected in parallel to the diode D1. The discharge unit 220 may include at least one of a switch, a diode, and a converter. The discharge unit 220 outputs a discharge current from the battery cell 210 through the first terminal P1 and the second terminal P2.

The temperature detecting unit 240 measures a temperature of the diode D1. In some embodiments, the temperature of the diode D1 is directly measured, as opposed to indirect measurement, such as, by measuring ambient air temperature. The temperature detecting unit 240 may include any of various temperature sensors. For example, a temperature sensor, such as [Note: please provide a list.] may be used. The temperature detecting unit 240 provides temperature data indicating the measured temperature to the BMS 230. The temperature data may be in the form of, for example, an analog voltage or a set of digital data.

The BMS 230 controls an overall operation of the battery pack 100a. The BMS 230 may monitor the battery 210, perform cell balancing of the battery cell 210, start or end charging and discharging, and communicate with the main control unit 140. The BMS 230 may be connected to the main control unit 140 through the third terminal P3.

The BMS 230 adjusts the charge current I1 of the power generation module 110 according to the temperature of the diode D1 measured by the temperature detecting unit 240. For example, in order to adjust the charge current I1 of the power generation module 110, the BMS 230 may transmit a control signal for requesting the main control unit 140 to adjust the charge current I1 of the power generation module 110. Alternatively, the BMS 230 may transmit the temperature data of the diode D1 to the main control unit 140 and the main control unit 140 may adjust the charge current I1 of the power generation module 110 according to the temperature data.

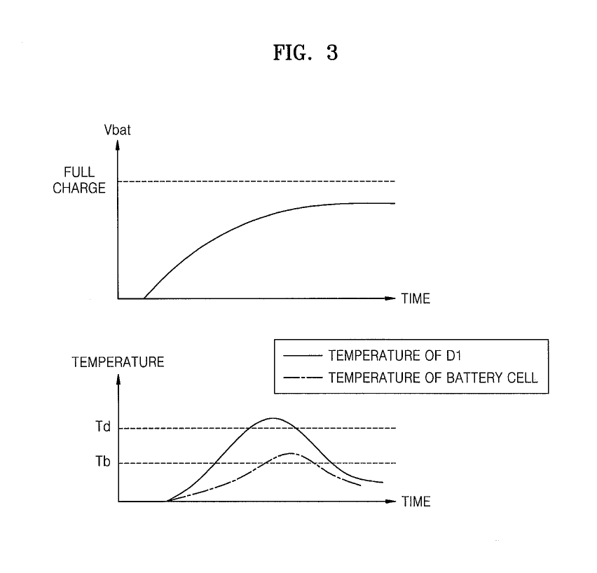

FIG. 3 shows graphs illustrating relationships between a voltage Vbat of the batter cell 210 and time and between a temperature of the diode D1 and a temperature of the battery cell 210 and time. The voltage Vbat of the battery cell 210 is an example of a state of charge (SOC) of the battery cell 210.

As shown in FIG. 3, as the SOC of the battery cell 210 changes from a full discharge state to a full charge state with time, the temperature of the diode D1 rapidly increases at an initial stage where the charge current I1 is high, and then reduces when the voltage Vbat of the battery cell 210 reaches a certain level and the charge current I1 is reduced. Since the temperature of the diode D1 rapidly increases at the initial stage, the diode D1 may break or characteristics of a device including the diode D1 may degrade. In particular, according to the present embodiment, since the diode D1 exhibits a voltage drop corresponding to a voltage difference between an output voltage of the power generation module 110 and a rated voltage of the battery cell 210, electric energy may be consumed by the diode D1 and thus a great amount of heat may be generated in the diode D1. Also, a temperature of the diode D1 may increase at a greater rate than a temperature of the battery cell 210. Accordingly, heat generated in the diode D1 may reduce the safety of the battery pack 100a.

Problems caused by heat generated in the diode D1 can be alleviated by adjusting the charge current I1 supplied from the power generation module 110 when the measured temperature of the diode D1 is equal to or greater than a first reference temperature Td. For example, when the diode's D1 temperature is equal to or greater than the first reference temperature Td, the BMS 230 or the main control unit 140 may reduce the charge current I1 supplied from the power generation module 110 or completely cut off the charge current.

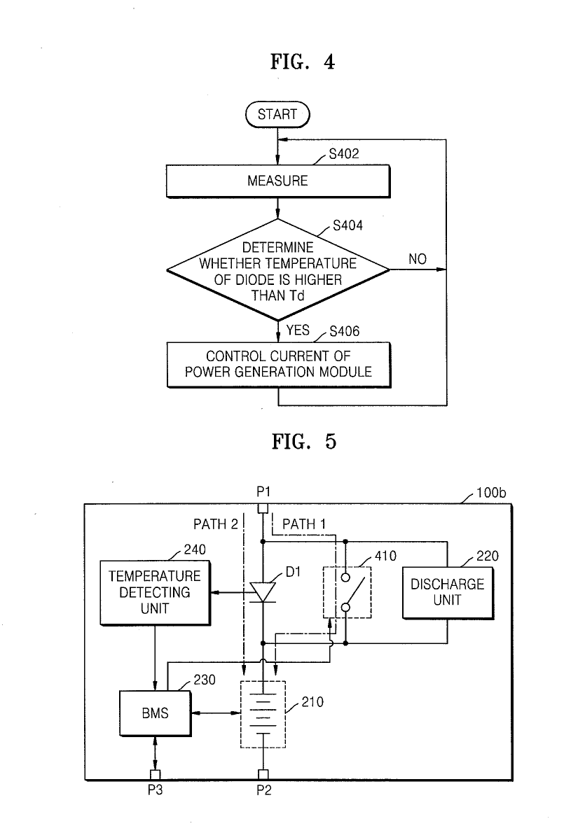

FIG. 4 is a flowchart illustrating a method of controlling the vehicle 10, according to an embodiment.

In operation S402, while the battery pack 110 operates, the temperature detecting unit 240 measures a temperature of the diode D1. The temperature of the diode D1 may be measured continuously, periodically, or in other ways.

In operation S404, it is determined whether the temperature of the diode D1 is greater than the first reference temperature Td. If it is determined in operation S404 that the temperature of the diode D1 is greater than the first reference temperature Td, the method proceeds to operation S406. In operation S406, the BMS 230 may request the main control unit 140 to reduce the charge current I1 output from the power generation module 110. Alternatively, if it is determined in operation S404 that the temperature of the diode D1 is greater than the first reference temperature Td, the BMS 230 may provide temperature data of the diode D1 to the main control unit 140 and the main control unit 140 may adjust the charge current I1 supplied from the power generation module 110 according to the temperature data of the diode D1 received from the BMS 230.

FIG. 5 is a block diagram illustrating a battery pack 100b according to another embodiment. As shown, the battery pack 100b includes the battery cell 210, the diode D1, the discharge unit 220, the BMS 230, the temperature detecting unit 240, and a bypass unit 410.

The diode D1 and the bypass unit 410 are connected in parallel between the first terminal P1 and the battery cell 210, and the bypass unit 410 may be turned on or off according to an SOC of the battery cell 210. The bypass unit 410 may include a switching element.

The BMS 230 measures an SOC of the battery cell 210 while the battery pack 100b operates. The BMS 230 allows the charge current I1 to flow along a first charge path PATH1 or a second charge path PATH2 according to the SOC of the battery cell 210.

For example, if the SOC of the battery cell 210 is equal to or less than a reference level, the BMS 230 allows the charge current I1 to flow through the first charge path PATH1 by turning on the switching element of the bypass unit 410. Accordingly, when the SOC of the battery cell 210 is equal to or less than the reference level, the charge current I1 minimally flows through the diode D1 and thus heat is substantially not generated in the diode D1.

When the SOC of the battery cell 210 is greater than the reference level, the BMS 230 allows the charge current I1 to flow through the second charge path PATH2 by turning off the switching element of the bypass unit 410. Accordingly, when the SOC of the battery cell 210 is greater than the reference level, the charge current I1 is supplied through the diode D1. Also, when the charge current I1 flows through the second charge path PATH2, the BMS 230 may monitor a temperature of the diode D1 by using the temperature detecting unit 240, and if the temperature of the diode D1 is equal to or greater than a first reference temperature, may adjust the charge current I1 supplied from the power generation module 110 according to the temperature of the diode D1. For example, if the temperature of the diode D1 is equal to or greater than the first reference temperature, the BMS 230 may request the main control unit 140 to reduce the charge current I1 supplied from the power generation module 110.

According to some embodiments, since at an initial stage where the battery cell 210 is not overcharged, the diode D1 does not experience any voltage drop D1 and the charge current I1 is supplied through the bypass unit 410, and at other stages when overcharging of the battery cell 210 is possible, the charge current I1 is supplied through the diode D1, and heat generated in the diode D1 may be monitored and reduced, if desired. Also, according to some embodiments, since the BMS 230 monitors a temperature of the diode D1 while being supplied with the charge current I1 through the diode D1 and reduces the charge current I1 if the temperature of the diode D1 is equal to or greater than a predetermined value, the safety of the battery pack 100 may be maintained.

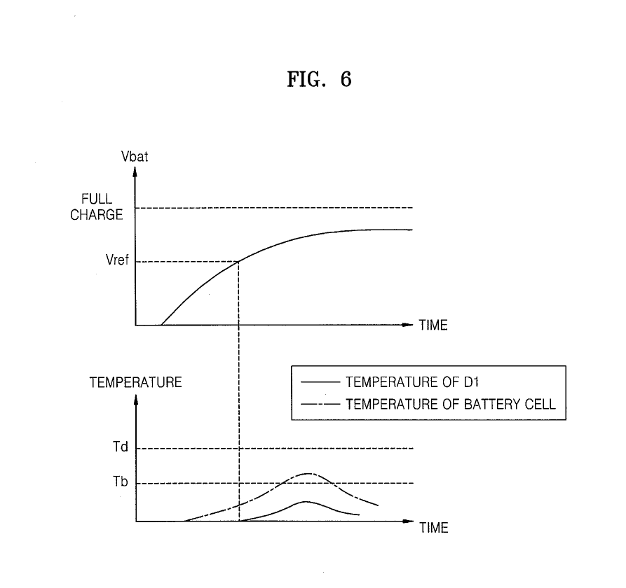

FIG. 6 includes graphs illustrating relationships between a voltage Vbat of the battery cell 210 and time and between a temperature of the diode D1 and a temperature of the battery cell 210 and time. The voltage Vbat of the battery cell 210 is an example of an SOC of the battery cell 210. According to some embodiments, as the SOC of the battery cell 210 changes from a full discharge state to a full charge state, if the voltage Vbat of the battery cell 210 is equal to or less than a first reference value Vref, since the charge current I1 flows along the second charge path PATH2, the temperature of the diode D1 is minimally changed and heat is substantially not generated in the diode D1. If the voltage Vbat of the battery cell 210 is greater than the first reference value Vref, since the charge current I1 flows along the first charge path PATH1, the temperature of the diode D1 begins to increase. As the SOC of the battery cell 210 approaches the full charge state, the charge current I1 flowing through the diode D1 is reduced. If the SOC of the battery cell 210 is equal to or greater than a predetermined state, heat is minimally generated in the diode D1 and the temperature of the diode D1 begins to reduce. As such, according to these embodiments, heat generated in the diode D1 is maintained at acceptable levels. Even when heat is generated in the diode D1, since the charge current I1 supplied from the power generation module 110 is adjusted according to a temperature of the diode D1, problems caused by the heat generated in the diode D1 are efficiently eliminated.

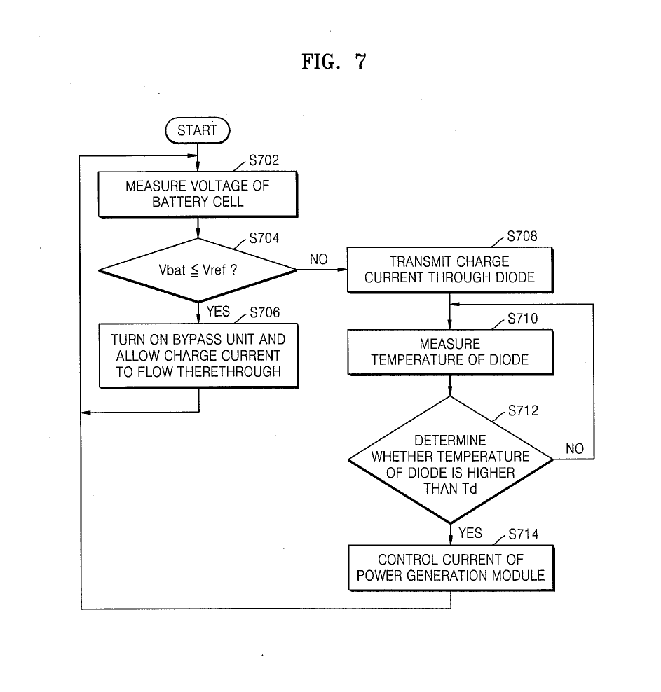

FIG. 7 is a flowchart illustrating a method of controlling the vehicle 10, according to another embodiment.

In operation S702, the voltage Vbat of the battery cell 210 is measured while the battery pack 100b is operating.

In operation S704, it is determined whether the voltage Vbat of the battery cell 210 is equal to or less than the first reference voltage Vref. If it is determined in operation S704 that the voltage Vbat of the battery cell 210 is equal to or less than the first reference voltage Vref, the method proceeds to operation S706. In operation S706, the bypass unit 410 is turned on and the charge current I1 flows along the first charge path PATH1.

If it is determined in operation S704 that the voltage Vbat of the battery cell 210 is greater than the first reference voltage Vref, the method proceeds to operation S708. In operation S708, the bypass unit 410 is turned off and the charge current I1 flows along the second charge path PATH2. In operation S710, the BMS 230 monitors a temperature of the diode D1, for example, by using the temperature measuring unit 240. In operation S712, it is determined whether the temperature of the diode D1 is equal to or greater than the first reference temperature Td. If it is determined in operation S712 that the temperature of the diode D1 is equal to or greater than the first reference temperature Td, the method proceeds to operation S714. In operation S714, the BMS 230 reduces the charge current I1 supplied from the power generation module 110.

As described above, according to the one or more of the above embodiments, a vehicle and a method of controlling the same may protect a device and ensure reliability thereof if, for example, there is a difference between an output voltage of a power generation module of the vehicle and a rated voltage of a battery cell in a structure where the battery cell is supplied with a charge current from the power generation module.

While various inventive aspects have been particularly shown and described with reference to exemplary embodiments using specific terms, the embodiments and terms have been used to explain the present invention and should not be construed as limiting the scope of the present invention. The exemplary embodiments should be considered in a descriptive sense only and not for purposes of limitation.

What is claimed is:

1. A vehicle having a rechargeable battery charging system, the vehicle comprising:
a battery cell configured to receive a charge current from a power generation module in order to be charged;
a diode connected in series between the power generation module and the battery cell and configured to conduct the charge current therethrough; and
a control unit that adjusts the charge current supplied from the power generation module according to a temperature of the diode.

2. The vehicle of claim 1, further comprising a temperature detection unit that measures the temperature of the diode.

3. The vehicle of claim 1, wherein the battery cell is a lithium-ion battery cell.

4. The vehicle of claim 3, wherein an output voltage of the power generation module is greater than a rated voltage of the lithium-ion battery cell, and wherein the diode exhibits a voltage drop corresponding to a voltage difference between the output voltage of the power generation module and the rated voltage of the lithium-ion battery cell.

5. The vehicle of claim 1, wherein the control unit is configured to reduce the charge current from the power generation module if the temperature of the diode is greater than a first reference temperature.

6. The vehicle of claim 1, further comprising an engine, wherein the power generation module generates the charge current from energy supplied from the engine.

7. The vehicle of claim 6, further comprising a starter motor that supplies power for starting up the vehicle and is supplied with a discharge current from the battery cell.

8. The vehicle of claim 1, further comprising a bypass unit that is disposed between the power generation module and the battery cell and comprises a switch connected in parallel to the diode, wherein the control unit is configured to turn on the bypass unit if a state of charge of the battery cell is less than a first reference value, and turns off the bypass unit if the state of charge of the battery cell is greater than the first reference value.

9. The vehicle of claim 8, wherein the control unit is configured to adjust the charge current from the power generation module according to the temperature of the diode only when the state of charge of the battery cell is greater than the first reference value.

10. The vehicle of claim 1, further comprising a discharge unit that is disposed between the power generation module and the battery cell, is connected in parallel to the diode, and allows a discharge current output from the battery cell to flow therethrough.

11. A method of controlling a vehicle that supplies a charge current to a rechargeable battery cell from a power generation module through a diode, the method comprising:
measuring a temperature of the diode; and
adjusting the charge current supplied from the power generation module according to the temperature of the diode.

12. The method of claim 11, wherein the battery cell is a lithium-ion battery cell.

13. The method of claim 12, wherein an output voltage of the power generation module is greater than a rated voltage of the lithium-ion battery cell, and wherein the diode exhibits a voltage drop corresponding to a voltage difference between the output voltage of the power generation module and the rated voltage of the lithium-ion battery cell.

14. The method of claim 11, wherein the adjusting of the charge current supplied from the power generation module comprises reducing the charge current supplied from the power generation module if the temperature of the diode is greater than a first reference temperature.

15. The method of claim 11, wherein the power generation module generates the charge current from energy supplied from an engine of the vehicle, wherein the adjusting of the charge current is controlled by a main control unit of the vehicle.

16. The method of claim 15, wherein the battery cell supplies a discharge current to a starter motor that supplies power for starting up the engine of the vehicle.

17. The method of claim 11, further comprising:
detecting a state of charge of the battery cell;
allowing the charge current to flow along a bypass path that is connected in parallel to the diode if the state of charge of the battery cell is less than a first reference value; and
cutting off the charge current flowing along the bypass path if the state of charge of the battery cell is greater than the first reference value.

18. The method of claim 17, wherein the adjusting of the charge current is performed only if the state of charge of the battery cell is greater than the first reference value.

19. A rechargeable battery charging system, comprising:
a battery cell configured to receive a charge current from a power generation module in order to be charged;
a diode connected in series between the power generation module and the battery cell and allows the charge current to flow therethrough; and
a control unit that adjusts the charge current supplied from the power generation module according to a temperature of the diode.

20. The system of claim 19, further comprising a bypass unit that is disposed between the power generation module and the battery cell and comprises a switch connected in parallel to the diode, wherein the control unit is configured to turn on the bypass unit if a state of charge of the battery cell is less than a first reference value, and turns off the bypass unit if the state of charge of the battery cell is greater than the first reference value.
